(19) United States
(12) Patent Application Publication
(10) Pub. No.: US 2023/0351289 A1
(43) Pub. Date: Nov. 2, 2023

(54) INTELLIGENT TASK MANAGEMENT

(71) Applicant: Citrix Systems, Inc., Fort Lauderdale, FL (US)

(72) Inventors: Jia Yin, Nanjing (CN); Chuchu Ye, Nanjing (CN); Jian Luo, Nanjing (CN); Ke Xu, Nanjing (CN)

(21) Appl. No.: 17/806,535

(22) Filed: Jun. 13, 2022

Related U.S. Application Data
(63) Continuation of application No. PCT/CN2022/090831, filed on Apr. 30, 2022.

(51) Int. Cl. G06Q 10/06

(52) U.S. Cl. CPC G06Q 10/06316; G06Q 10/063114

(57) ABSTRACT

According to some embodiments, a method includes: receiving, by a computing device, information about a task of application, the task associated with a project; receiving, by the computing device, information about other tasks of the application including other tasks that have been completed and other tasks that have not been completed; calculating, by the computing device, a start date and an expected effort for the task based on analysis of the information received for the task and the other tasks; and causing, by the computing device, an update within the application to apply the calculated start date and expected effort to the task.

### CROSS REFERENCE TO RELATED APPLICATIONS

This application is a continuation of and claims the benefit of PCT Patent Application No. PCT/CN2022/090831 filed on Apr. 30, 2022 in the English language in the State Intellectual Property Office and designating the United States, the contents of which are hereby incorporated herein by reference in its entirety.

### BACKGROUND

Organizations use project management systems to plan, organize, and various types of projects. A project management system can provide features such as estimation and planning, scheduling, cost control and budget management, resource allocation, communication, decision-making, quality management, and time management. Software-as-a-service (SaaS) and cloud-based project management systems are an increasing popular choice for organizations looking to access information from any location and using various types of devices, such as desktop, laptop, tablet, and mobile devices.

Some project management systems, such as WRITE and JIRA, allow an organization to break large projects up into a set of smaller tasks (or “tickets”) that can be assigned to different users of the organization. A particular task can be assigned a start date and a value indicating how much effort is expected for completion the task (“expected effort”). In some cases, expected effort may be expressed as a unitless number referred to as a “story point.” A story point is a metric used in agile project management and development to estimate the difficulty of implementing a given task (or “user story”). In other cases, expected effort may be expressed as a duration of time, such as a number of hours or days expected for completion of the task.

### SUMMARY

With existing project management systems, the state date and the expected effort required to complete a given task may be determined/estimated in a manual fashion, which can lead to inaccurate, unpredictable, and inefficient project planning and execution. For example, a project manager may rely on their subjective judgment when assigning an expected effort to a task, which is likely to be inaccurate or unrealistic. As another example, if a project has a large number of tasks (e.g., hundreds or thousands of tasks), a project manager may resort to assigning start dates to tasks in a somewhat arbitrary fashion as a matter of practicality. It is recognized herein that it can be more efficient to, instead, group related tasks such that they are worked on at or around the same time (e.g., during consecutive time periods).

Described herein are embodiments of systems and methods for providing automated task management using machine learning/intelligence (i.e., “intelligent task management”). Disclosed embodiments can calculate, in an automated fashion, the expected effort for a task based on historical data collected for other tasks. Disclosed embodiments can also calculate, in an automated fashion, a start date for a task based on identifying and grouping related tasks. Disclosed embodiments can automatically reorder lists of tasks to accommodate such intelligent grouping.

Disclosed embodiments can be applied to improve existing project management systems by, for example, accurately calculating the expected effort of individual tasks and, thus, of projects overall. Moreover, by intelligently grouping related tasks together, disclosed embodiments can reduce the time to complete a project, including projects that consume computing resources such as software development projects. Thus, embodiments of the present disclosure not only increase user productivity, but also can reduce computer resource usage, such as processor, network, and storage usage.

According to one aspect of the present disclosure, a method can include: receiving, by a computing device, information about a task of application, the task associated with a project; receiving, by the computing device, information about other tasks of the application including other tasks that have been completed and other tasks that have not been completed; calculating, by the computing device, a start date and an expected effort for the task based on analysis of the information received for the task and the other tasks; and causing, by the computing device, an update within the application to apply the calculated start date and expected effort to the task.

In some embodiments, the information about the task and the other tasks can be received from an agent running within the application. In some embodiments, the receiving of the information about the other tasks that have not been completed can include receiving information about tasks assigned to the same user as the task and associated with the same project as the task.

In some embodiments, the calculating of the start date for the task can include: calculating similarity scores between the task and ones of the other tasks that have not been completed using the information received about the task and the other tasks that have not been completed; determining a task from among the other tasks that have not been completed having a highest one of the calculated similarity scores; and calculating the start date of the task based on an end date of the task from among the other tasks that have not been completed having the highest one of the calculated similarity scores.

In some embodiments, the information received about the task can include values of the task for a plurality of attributes, wherein the information received about the other tasks that have not been completed includes values of the ones of the other tasks that have not been completed for the plurality of attributes, and wherein calculating the similarity score between the task and one of the other tasks that have not been completed includes: for ones of the plurality of attributes, calculating discrete similarity scores between the task and the one of the other tasks that have not been completed using the corresponding attribute values received for the task and the one of the other tasks that has not been completed; and calculating the similarity scores as a weighted sum of the discrete similarity scores.

In some embodiments, the receiving of the information about other tasks that have been completed can include receiving information about other tasks that have been completed by users different from a user to whom the task is assigned. In some embodiments, the receiving of the information about other tasks that have been completed can include receiving information about other tasks that are associated with another project different from the project with which the task is associated.

In some embodiments, the calculating of the expected effort for the task can include: identifying ones of the other tasks that have been completed that are similar to the task based on comparing the information received about the task and the other tasks that have been completed; and calculating an average of actual effort expended on the ones of the tasks that have been completed that are similar to the task. In some embodiments, the identifying of the ones of the other tasks that have been completed that are similar to the task can include: identifying keywords within the information received for the task; for ones of the other tasks that have been completed: identifying keywords within the information received for the one of the other tasks that have been completed; and calculating a similarity score between the task and the one of the other tasks that have been completed using the respective keywords.

In some embodiments, the identifying of the keywords within the information received and the identifying of the keywords within the information received for the ones of the other tasks that have been completed can include using a term frequency-inverse document frequency (TF-IDF) measure. In some embodiments, the calculating of the similarity score between the task and the one of the other tasks that have been completed using the respective keywords can include using a cosine similarity measure.

In some embodiments, the calculating of the average of the actual effort expended on the ones of the tasks that have been completed that are similar to the task can include: separating the ones of the tasks that have been completed that are similar to the task into first similar tasks that are assigned to a user to whom the task is also assigned and second similar tasks that are assigned to users other than the user to whom the task is assigned; calculating an average of actual effort expended on the first similar tasks; and calculating a weighted average of actual effort expended on the second similar tasks. In some embodiments, the calculating of the weighted average of the actual effort expended on the second similar tasks can include, for ones of the second similar tasks, determining a weight based on a difference in level of the user to whom the one of the second similar tasks is assigned and the user to whom the task is assigned.

In some embodiments, the method can further include: responsive to the calculating of the start date for the task, determining a modified start date for at least one of the one or more of the other tasks that have not been completed; and causing an update within the application to apply the modified start date to the at least one of the one or more of the other tasks that have not been completed within the application.

According to another aspect of the present disclosure, a method can include: detecting, by a computing device, creation of a task within an application, the task associated with a project; receiving, by the computing device, information about other tasks of the application including other tasks that have been completed and other tasks that have not been completed; receiving, by the computing device, a recommended start date and expected effort for the task using the information received for the task and the other tasks; and updating, by the computing device, the task within the application to apply the recommended start date and expected effort to the task.

In some embodiments, the detecting of the creation of a task within an application can include detecting of the creation of the task includes detecting an input on a user interface (UI) control of the application. In some embodiments, the updating of the task within the application can include update one or more UI controls of the application to display the calculated start date and expected effort. In some embodiments, the updating of the task within the application can include updating a database to store the calculated start date and expected effort for the task. In some embodiments, the receiving of the recommended start date and expected effort for the task can include sending a request to another computing device, the request including information about the task and the information received about other tasks of the application.

According to another aspect of the present disclosure, a computing device can include: a processor and a non-volatile memory storing computer program code that when executed on the processor causes the processor to execute a process. The process can be the same as or similar to any of the aforementioned method embodiments.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a diagram of a network computing environment in which intelligent task management can be performed, according to embodiments of the present disclosure.

FIGS. 5A-5C are pictorial diagrams of user interfaces (UIs) that can be used in conjunction with intelligent task management, according to embodiments of the present disclosure.

FIG. 6 is an interaction diagram showing examples of interactions that can occur within the network computing environment of FIG. 4, according to embodiments of the present disclosure.

FIGS. 7-10 are flow diagrams showing illustrative processes for intelligent task management, according to embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

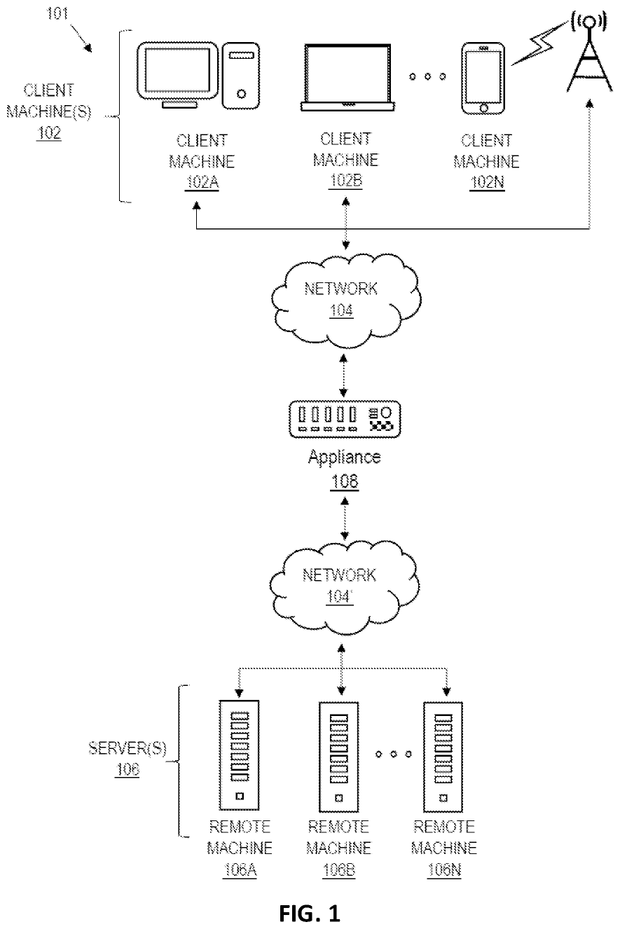

Referring now to FIG. 1, shown is an example network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

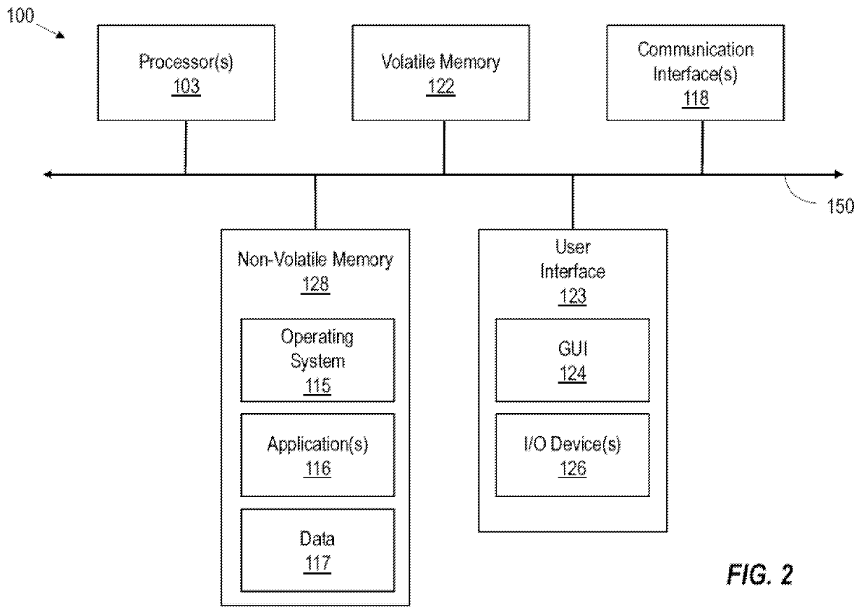

FIG. 2 is a block diagram illustrating selective components of an example computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an example client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

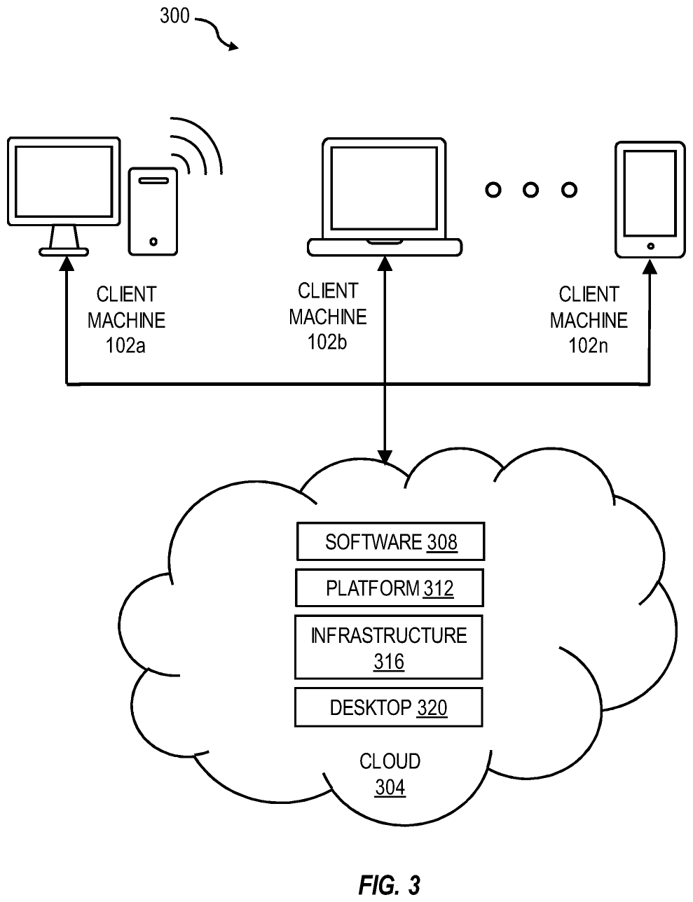

Referring to FIG. 3, a cloud computing environment 300 is depicted, which may also be referred to as a cloud environment, cloud computing or cloud network. The cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 300, one or more clients 102a-102n (such as those described above) are in communication with a cloud network 304. The cloud network 304 may include back-end platforms, e.g., servers, storage, server farms or data centers. The users or clients 102a-102n can correspond to a single organization/tenant or multiple organizations/tenants. More particularly, in one example implementation the cloud computing environment 300 may provide a private cloud serving a single organization (e.g., enterprise cloud). In another example, the cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 300 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 102. In some embodiments, the cloud computing environment 300 can include or provide monitoring services to monitor, control and/or generate reports corresponding to the provided shared services and resources.

In some embodiments, the cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

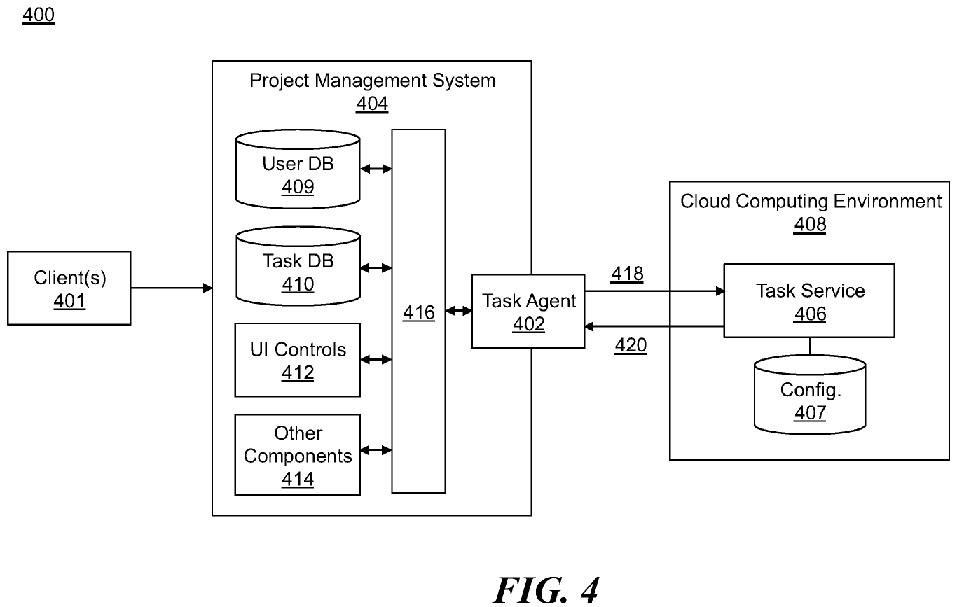

FIG. 4 shows an example of a network computing environment 400 in which intelligent task management can be performed, according to embodiments of the present disclosure. Illustrative network computing environment 400 can include one or more clients 401, a task agent 402 that can interface with a project management system 404, and a task service 406 that can run within a cloud computing environment 408. Clients 401, task agent 402, and task service 406 can communicate via one or more computer networks (not shown) to enable for automated an intelligent management of tasks within project management system 404. Task agent 402 and task service 406 can include hardware and/or software configured to perform various processing described herein in conjunction with these components. In some embodiments, cloud computing environment 408 can include any or all of the components described above in conjunction with cloud computing environment 300 of FIG. 3.

The project management system 404—which may correspond to an existing project management system, such as WRITE or JIRA—can include a user database 409, a task database 410, user interface (UI) controls 412, and various other components 414 for providing project management functions (e.g., estimation and planning, scheduling, cost control and budget management, resource allocation, communication, decision-making, quality management, and time management). Project management system 404 can enable clients 401 to create projects, create tasks within a project, assign tasks to users, among other functions.

Project management system 404 can be used by many different clients 401 associated with users of one or more different organizations. Project management system 404 can store information about particular users within user database 409. For example, for a given user, user database 409 may be configured to store information about which organization the user is associated with, information about which role(s) the user has within the organization, and/or information about which groups (or “teams”) the user is assigned to within the organization. In this way, user database 409 can be queried to identify various information about individual users. In addition, user database 409 can be queried to identify users within the same organization, users having the same role, and users within the same group. For the purpose of this disclosure, users within the same organization, role, and/or group may be referred to as “peers.”

Project management system 404 can be used to manage many different projects associated with one or more different organizations. A given project can have many different tasks (or “tickets”) associated with it, whereby different tasks can be assigned to different users (e.g., different users associated with the same organization as the project).

Task database 414 can be configured to store various information about one or more tasks created and managed via project management system 404. For example, for a given task, task database 414 may be configured to store a title of the task, a description of the task, information identifying one or more components of the project the task is associated with, and information identifying one or more labels assigned to the task. For the purpose of this disclosure, each of these items of information can may be referred to as an “attribute” of a task, and the corresponding value(s) stored for the task may be referred as the “attribute value(s)” of the task.

Task database 414 may also be configured to store, for a given task, information identifying the project the task belongs to, information identifying the user the task is assigned to, a start date for the task, an expected effort for the task, and a status of the task. The status can be a value from a set of possible statuses, which set can be defined within project management system 404 on a per-project or per-organization basis. For example, a defined set of possible statuses can include the values “new,” “in progress,” or “completed.” For the purpose of this disclosure, a task that has a status of “completed” (or some equivalent value) is referred to as a “completed” or “historical task.” In contrast, a task having a status other than “completed” is referred as a “planned” or “not completed” task.

In some embodiments, task database 414 may also be configured to store, for a given task, the actual date work was started on the task (“actual start date”) and the actual date work was completed on the task (“actual end date”). The actual start date and end date can be used to calculate actual amount of effort expended on the task (“actual effort”). Alternatively, and equivalently, task database 414 may directly store the actual effort for a task. The actual start date, end date, and/or actual effort may be tracked by the project management system 404. For example, in response to a user input or other event that changes a task's status from “new” to “in progress,” project management system 404 may store the task's actual start date to the current date/time. The actual start date can differ from the assigned start date if, for example, the user to whom the task is assigned was unavailable to start the task on the assigned date. As another example, in response to a user input or other event that changes a task's status from “in progress” to “completed,” project management system 404 may store the task's actual end date based on the current date. Alternatively, or in addition to, project management system 404 may store the actual effort expended on the task. In some embodiments, task start dates and end dates may correspond to datetime values.

In some embodiments, expected effort may be stored as a unitless number (e.g., a story point). In other embodiments, expected effort may be stored as a duration of time, such as a number of hours or days expected for a user to complete the task. In some embodiments, the expected duration of time to complete a task can be calculated based on a story point value associated with the task. For example, an organization may, by convention, may treat N story points to be equal to M working days/hours. In some embodiments, an organization may define a linear relationship between story points and working days/hours, such as M=N or, more generally, M=AN+B where A and B are constant. In some embodiments, an organization may define a mapping between story points and numbers of hours/days, such as {1 point: 1 hour, 2 points: 4 hours, 3 points: 1 day, 4 points: 2 days}. Thus, regardless of how expected effort is stored, environment 400 can calculate an expected end date for a task using the start date and expected effort value stored for the task. As discussed in detail below, information stored within task database 410 can be used to automatically identify related tasks for the purpose of intelligent task management.

Task database 410 can be queried for tasks associated with a given user, project, or organization. Moreover, task database 410 can be joined with user database 409 to retrieve historical tasks assigned to peers of a given user (e.g., a user to whom a newly created task is assigned) and/or to retrieve planned tasks that are assigned to a given user. Such queries can be utilized by task agent 402 for the purpose of intelligent task management.

UI controls 412 can include various UI controls for providing project management-related functions. For example, UI controls 412 can include controls for creating new tasks associated with a project, for editing/modifying existing tasks associated with a project, and for viewing lists of tasks associated with particular projects and/or assigned to particular users. In some embodiments, UI controls 412 can include one or more forms for creating and editing tasks. For example, UI controls 412 can include a form for creating or editing a task that includes an input for selecting a user to assign the task to, an input for entering a start date for the task, and an input for entering an expected effort for the task. In some embodiments, UI controls 412 can include one or more controls for viewing a list of tasks associated with a particular project or user, where the list of tasks may be ordered by their respective start dates.

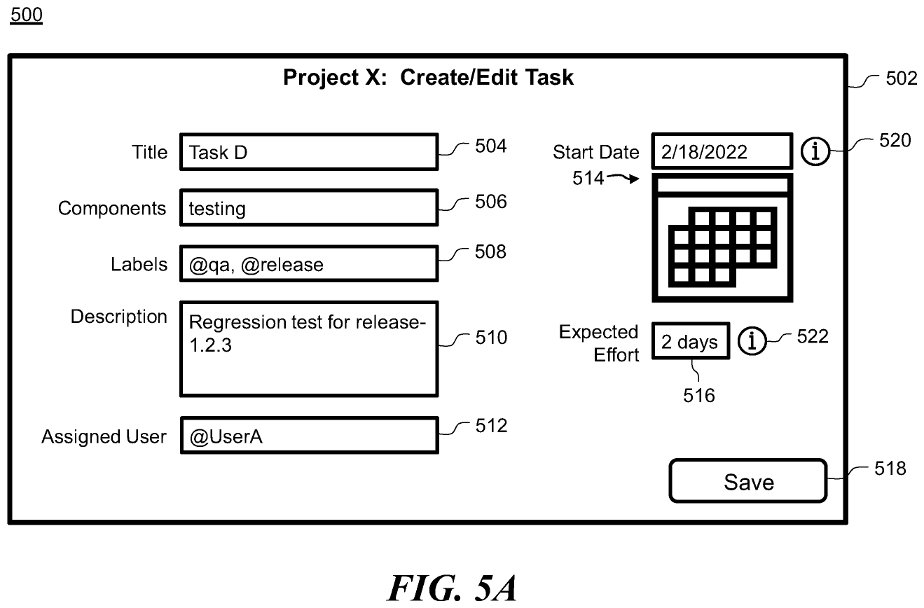

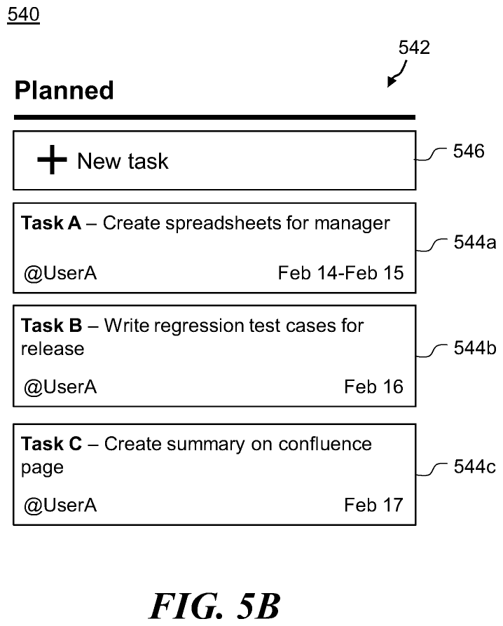

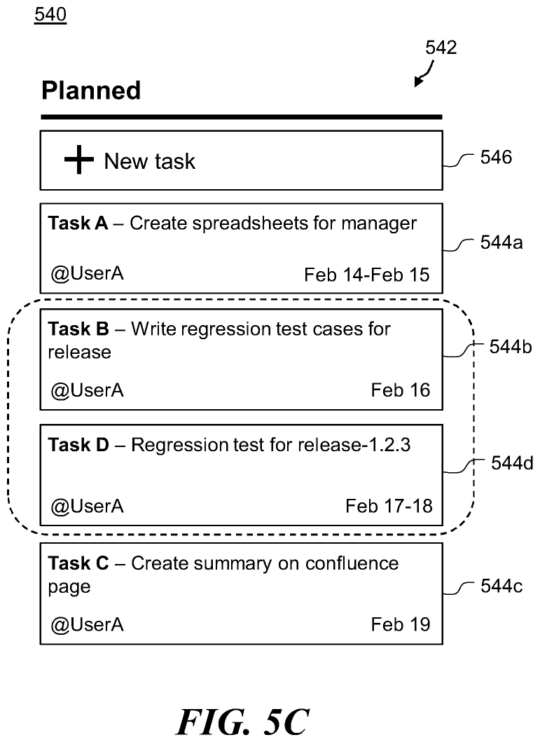

In addition to providing conventional project management-related functions, UI controls 421 can include controls for intelligent task management. For example, UI controls 421 can include one or more controls (e.g., buttons) for obtaining a recommended start date and/or a recommended expected effort for a given task. In some embodiments, UI controls 421 can include one or more of the controls show in FIGS. 5A-5C and described below in the context thereof.

In some cases, project management system 404 may be a SaaS project management system and UI controls 412 may correspond to elements of web pages rendered thereby. Here, clients 401 can include a web browser configured to render and interact with such web pages to enable task creation, editing, viewing, and other project management functions. In some embodiments, project management system 404 may provide a RESTful API or other type of HTTP-based API that clients 401 can use to manage tasks.

Task agent 402 can interface with the various components 409, 410, 412, 414 of project management system 404 to provide intelligent task management. For example, task agent 402 may utilize an application programming interface (API) 416 of project management system 404 to interface with components 409, 410, 412, 414. In some embodiments, task agent 402 may be implemented as an extension/plugin to project management system 404 and API 416 may correspond to an extension/plugin programming interface provided by to project management system 404. In some embodiments, task agent 402 may be implemented as a standalone process running on the same server as project management system 404 and API 416 may correspond to an inter-process communication (IPC) mechanism that enables task agent 402 to interface with components 409, 410, 412, 414. In some embodiments, task agent 402 may be implemented as a standalone application process, or as part of another application process, that can run on a device separate from project management system (e.g., on a client 401). Here, task agent 402 may communicate with project management system 404 via one or more computer network and API 416 may correspond to, for example, a RESTful API or other type of HTTP-based API. In some embodiments, task agent 402 may be implemented as part of a resource access application, such as CITRIX WORKSPACE, configured to run on the one or more of clients 401. In some embodiments, task agent 402 may directly interface with databases 409, 410 to read and write task data. For example, API 416 may include, or correspond to, a client-server interface provided by relational database management system (RDBMS) of which databases 409, 410 form a part of.

Task agent 402 can obtain a recommended start date and/or expected effort for a given task (“subject task”) in response to one or more events or inputs. In some embodiments, task agent 402 can use API 416 to detect when a new task has been created within project management system 404 or when an existing task has been modified. For example, task agent 402 may listen for a task creation/modification event using API 416 and, in response, can obtain a recommended start date and/or expected effort for the subject task. In this way, intelligent task management can be performed in an automated fashion, without user input. In some embodiments, task agent 402 can use API 416 to detect one or more user inputs related to a task, such inputs on recommendation buttons provided by UI controls 412. For example, task agent 402 may listen for such user inputs using API 416 and, in response, can obtain a recommended start date and/or expected effort for the subject task. In this way, intelligent task management can be performed at the behest of a client/user (or “on demand”).

In either case, in response to detecting an event/input, task agent 402 can receive information about the subject task and/or the user to whom the subject task is assigned. For example, task agent 402 may retrieve the task and user information from task database 410 and user database 409, respectively. As another example, task agent 402 may receive the task and/user information from one or more of the UI controls 412 being used to create/edit the task (e.g., from a form actively being for the creation/modification of a task).

Having received the information about the subject task, task agent 402 can send a request 418 to task service 406 to obtain a recommend start date and/an expected effort for the subject task. The request 418 (or “recommendation request”) can include any or all of the information stored for the task within task database 410 in addition to any or all of the information stored for the user within user database 409. In some embodiments, task service 406 may provide an API (e.g., a RESTful API or other type of HTTP-based API) that can be used by task agent 402 for making recommendation requests and receiving responses thereto. In some embodiments, task agent 402 may send separate recommendation requests 418 to obtain a start date and an expected effort for a subject task. In some embodiments, task agent 402 may send a single recommendation request 418 to obtain both the start date and the expected effort.

As will be discussed in detail below, task service 406 can utilize information about other tasks associated with the same project, user, and/or organization to recommend a start date and an expected effort for a subject task. For example, task service 406 may utilize information about tasks that have been completed (“historical tasks”) and/or information about tasks that have not yet been completed (“planned tasks”). In some embodiments, the historical tasks can include historical tasks that are, or were, assigned to peers of the user to whom the subject task is assigned. In some embodiments, the planned tasks can include planned tasks that are assigned to the same user as the subject task and/or that are associated with the same project as the subject task. In order to provide information about such other tasks to task service 406, task agent 402 can retrieve the information from task database 410 using API 416 and include the retrieved information as part of a recommendation request 418. In some embodiments, task agent 402 can execute a query that joins task database 410 and user database 409 to retrieve historical tasks assigned to peer users and/or planned tasks assigned to the same user and/or associated with the same project. In some embodiments, task agent 402 can retrieve information about planned tasks that have a start date within a given time period, such as tasks that have a start date within the next N days, weeks, or months. Task agent 402 can include any or all of the information received about historical and/or planned tasks within the recommendation request 418 sent to task service 406.

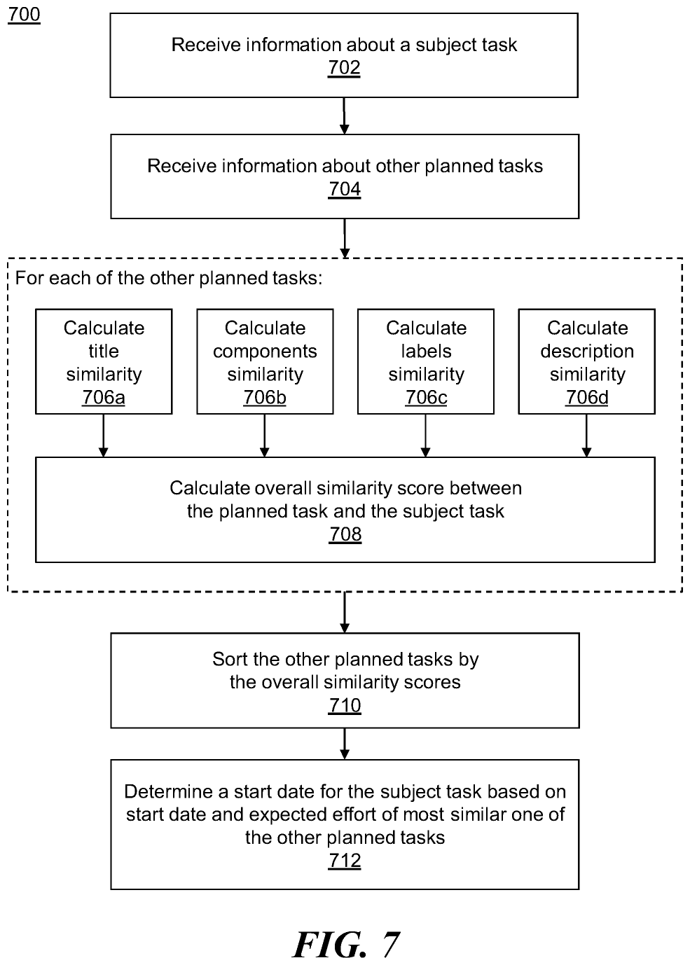

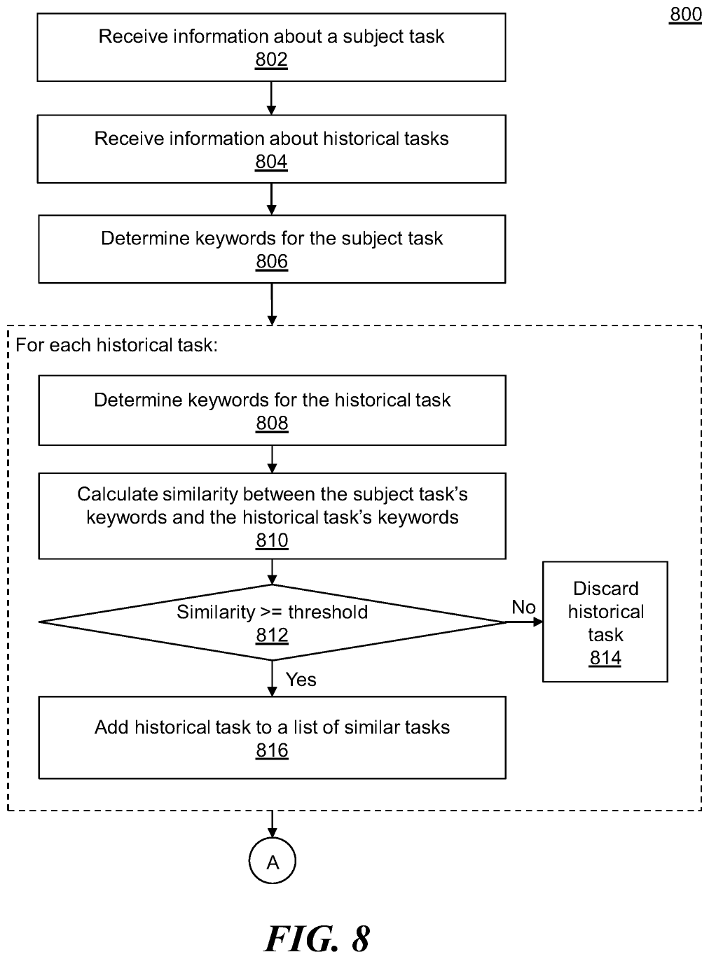

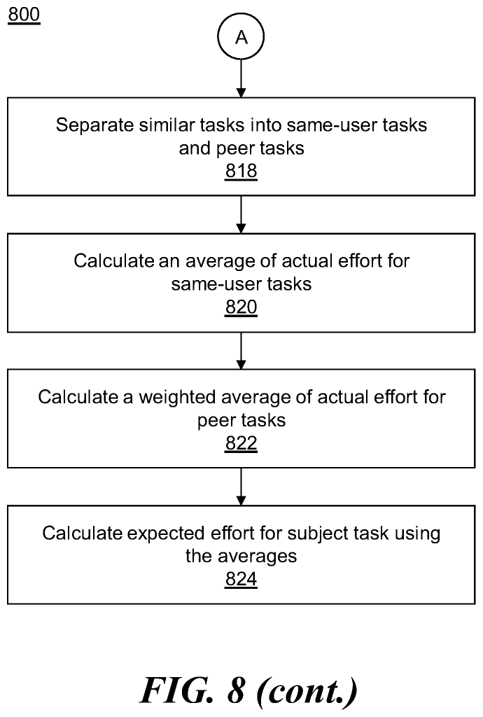

In response to receiving a recommendation request 418, task service 406 can calculate a recommend start date and/or an expected effort for a subject task. Examples of techniques that can be used for calculating recommend start date and expected effort values are described in detail below in the context of FIGS. 7 and 8. Briefly, to recommend a start date for a subject task, task service 406 can analyze other planned tasks (e.g., other planned tasks assigned to the same user and associated with the same project) to identify related tasks that, at as a matter of efficiency, should be grouped together (e.g., worked on during consecutive time periods). To recommend the expected effort for the new task, task service 406 can analyze information about historical tasks assigned to the same user as the new task and/or peers thereof. Task service 306 can return the recommended start date and/or expected effort to task agent 402 via a response 420 (or “recommendation response”).

In some cases, task service 406 may recommend modifying the start dates of one or more other planned tasks to accommodate work on subject task. For example, if task service 406 recommends a start date of Feb. 17, 2022, and an expected effort of 2 days for a subject task and another planned task assigned to the same user and/or associated with the same project has a start date of Feb. 17, 2022, task service 406 can further recommend that the start date of the other task be changed to Feb. 19, 2022. Likewise, task service 406 can recommend that other tasks assigned to the same user and/or associated with the same project that are scheduled to start after Feb. 17, 2022 be rescheduled. Task service 306 can return information about such modifications to other planned tasks as part of a recommendation response 420.

In some embodiments, task service 406 may be implemented as lightweight service within cloud computing environment 408. In some embodiments, task service 406 may be deployed as a container, such as a DOCKER container. In some embodiments, task service 406 and project management system 404 may run within the same cloud computing environment. In some embodiments, some or all of the processing described herein in conjunction with task service 406 may be implemented and performed within task agent 402. For example, task agent 402 can be configured to recommend start dates and expected efforts for one or more tasks directly using information it receives from project management system 404. Thus, in some embodiments, task service 406 can be omitted from network environment 400.

In some embodiments, task service 406 can access a configuration database 407 that that stores various configuration settings used for intelligent project management that are discussed herein. In some embodiments, configuration database 407 may store per-organization, per-user, and/or per-project configuration settings, policy, and/or preferences for intelligent task management. In some embodiments, configuration database 407 may correspond to a storage service provided by cloud computing environment 408. In some embodiments, configuration database 407 may correspond to a storage means within an external application/service that task service 406 can interface with (e.g., using a SaaS API provided thereby).

Having received a recommendation response 420, task agent 402 can cause the subject task to be updated within project management system 404. For example, task agent 402 can use API 416 to cause the subject task's start date and expected effort to be updated within task database 410 (e.g., by executing a database update statement against database 410). With this approach, the recommended start date and/or expected effort may be displayed by UI controls 412 when the subject task, or a list of tasks that includes the subject task, is subsequently accessed using said UI controls. As another example, task agent 402 can use API 416 to cause the subject task's recommended start date and/or expected effort to be updated within one or more of the UI controls 412 that are actively being used to create/edit/view the subject task, or within one or more of the UI controls 412 that are being used to view a list of tasks that includes the subject task. Thus, with this approach, the one or more of the UI controls 412 may be updated dynamically (or “in place”) to display the recommended start date and/or expected effort. In the case where a list of tasks, ordered by start date, is being viewed using UI controls 412, the list may be dynamically rearranged based on a new start date recommended for the subject task.

In some embodiments, task agent 402 can also update the start date of one or more other planned tasks as recommended by task service 406. For example, task agent 402 can use API 416 to cause the start dates of the other tasks to be updated within task database 410. As another example, task agent 402 can use API 416 to cause the start dates of the one or more other planned tasks to be updated within one or more of the UI controls 412 that are actively being used to create/edit/view the other planned tasks, or within one or more of the UI controls 412 that are being used to view a list of tasks that includes one or more of the other planned tasks.

FIGS. 5A-5C shows an illustrative UIs that can be used in conjunction with intelligent task management, according to embodiments of the present disclosure. For example, some or all of the UI controls shown in FIGS. 5A-5C may be implemented within the project management system 404 and/or within task agent 402 of FIG. 4.

Turning to FIG. 5A, a UI 500 may be used for creating a new task or editing an existing task within a project management system. A similar UI can be used for viewing existing tasks.

Illustrative UI 500 includes a task form 502 which can have, for example, a title input 504 for entering a title for a task, a components input 506 for entering/selecting components with which the task is associated, a labels input 508 for entering/selecting labels for the task, a description input 510 for entering a description for the task, a user assignment input 512 for entering/selecting a user to whom the task is to be assigned, one or more controls 514 for entering/selecting a state date for the task, an expected effort input 516 for entering an expected effort value for the task, and a save button 518. In some embodiments, expected effort input 516 can be configured to receive a unitless integer value (e.g., a story point). In other embodiments, expected effort input 516 can be configured to receive a duration of time, such as a number of hours or days.

In response to a click, tap, or other type of input on save button 518, UI 500 can cause the values of inputs 504, 506, 508, 510, 512, 516 to be saved to a database (e.g., task database 410 of FIG. 4) in association with the newly created task or the existing task being edited.

The illustrative task form 502 can also include one or more UI controls for obtaining a recommended start date and/or a recommended expected effort for the task being created/edited. For example, as shown, task form 502 can include a first recommendation button 520 for obtaining a recommended start date for the task and a second recommendation button 522 for obtaining a recommended expected effort for the task. In response to an input on first or second recommendation button 520, 522, UI 500 can cause a task agent to send a recommendation request to a task service. For example, referring to both FIGS. 4 and 5, in response to an input on first recommendation button 520, task agent 402 can detect the input and send a send a request 418 to task service 406 to recommend a start date for the task. After receiving a recommendation response 420 from task service 406, task agent 402 can provide UI 500 with the recommended start date and UI 500 can update the start date input controls 514 with the recommended start date. A similar set of interactions can occur to update the expected effort input 516 with a value recommended by task service 406.

Turning to FIG. 5B, an illustrative UI 540 may be used for viewing a list of planned tasks associated with a particular project and/or assigned to a particular user. For example, as shown, UI 540 can display planned tasks assigned to “User A.” In other examples, UI 540 can be used to display planned tasks assigned to multiple different users and/or unassigned tasks. For example, UI 540 may be used to display all planned tasks for a given project.

Illustrative UI 540 includes a list view 542 having one or more task displays 544a, 544b, 544c (544 generally) to display information about one or more corresponding tasks stored within a project management system. A particular task display 544, can display the title of the corresponding task, the description of the task, information identifying the user to whom the task is assigned, and the start and/or end date of the task. If the start date and end date are the same for a particular task, the corresponding task display 544 may display just that one date, for conciseness. For example, task display 544a is shown as displaying a task titled “Task A”, having the description “Create spreadsheets for manager,” assigned to User A, and having both a start date and an end date of “February 12.” As previously discussed, the end date can be calculated based on the start date and the expected effort stored for the task, converting from story point to a duration of time as needed. The task displays 544a, 544b, 544c may be ordered by start date, as shown.

In the simplified example of FIG. 5A, three tasks (corresponding to task displays 544a, 554, 544c) are shown as having different start dates. In practice, a task list showing tasks assigned to a particular user may include two or more tasks with the same start date, indicating that the user is expected to complete at least one of those tasks in less than a day. While only three task displays 544 are shown in the example of FIG. 5B, UI 540 can be used to display a task list 542 having an arbitrary number of tasks.

Illustrative list view 542 can also include a control 546 for initiating the creation of new tasks. In response to an input on new task control 546, UI 540 can cause the project management system to display another UI for creating a new task, such as UI 500 of FIG. 5A.

Turning to FIG. 5C, in which like elements of FIG. 5B are shown using like reference numerals, newly created tasks can be added to the task list 542 and positioned within the list based on their respective start dates. In the example of FIG. 5B it is assumed that a new task, represented by task display 544d, is created and assigned to “User A,” where the task has the title “Task D” and the description “Regression test for release-1.2.3.” The new task of display 544d also has a start date of February 17 and an expected effort of 2 days, which values may be calculated in an automated and intelligent fashion using structures and techniques disclosed herein. For example, the start date of the new task (“Task D”) can be calculated based on a determination that the new task is related to another task (“Task B”) represented by task display 544b and, thus, these two tasks should be grouped together as a matter of efficiency. Other planned tasks having a start date on or after February 17 may be automatically modified to have later start dates (i.e., postponed/rescheduled). For example, the start date of the task represented by task display 544c (“Task C”) may be changed from February 17 to February 19, after work on the new task (“Task D”) is expected to be completed.

Thus, as illustrated by FIGS. 5B and 5C, the structures and techniques disclosed herein can be used to automatically reorder task lists, which can increase user productivity and reduce the time/effort/resources needed to complete a project.

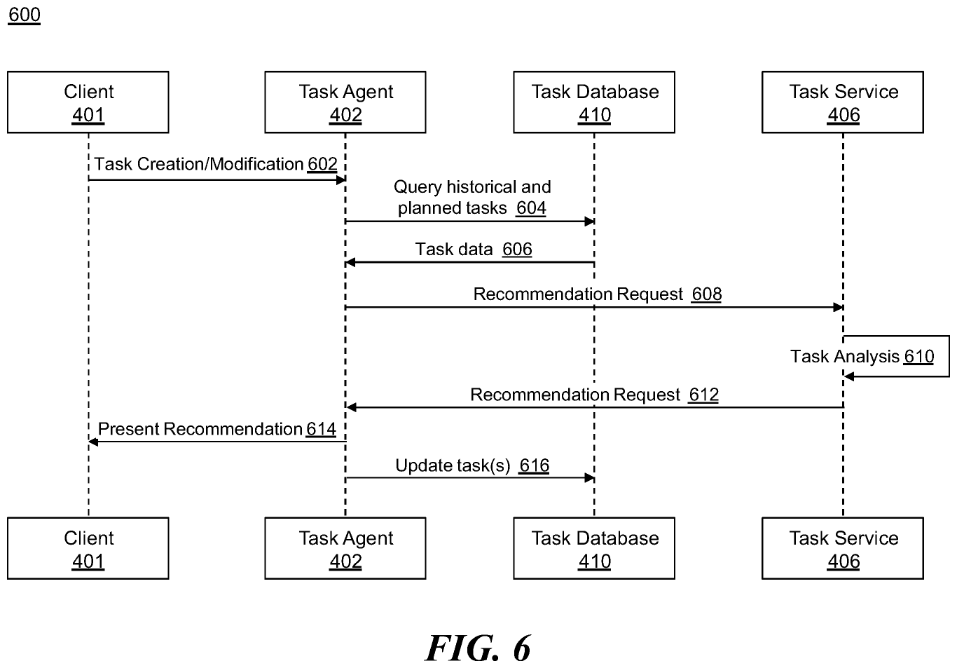

FIG. 6 shows interactions that can occur within the network computing environment of FIG. 4, according to embodiments of the present disclosure. Like elements of FIG. 4 are shown using like reference numerals in FIG. 6.

At 602, client 401 can initiate the creation or modification of a task (“subject task”) associated with a project. For example, client 401 can utilize one or more UIs provided by project management system 404 to create/modify a task. Task agent 402 can interface with project management system 404 to detect the task creation/modification and receive information about the subject task, such as a title, one or more components, one or more labels, a description, and a user to whom the subject task is assigned.

At 604, in response to the detection of the task creation/modification, task agent 402 can query task database 410 for information about historical and planned tasks. In some embodiments, task agent can query database 410 for information about historical tasks assigned to the same user as the subject task and/or historical tasks assigned to peers thereof. In some embodiments, task agent 402 can query database 410 for information about planned tasks that have a start date within a given time period, such as tasks that have a start date within the next N days, weeks, or months. In some embodiments, task agent 402 can also query user database 409 to retrieve such information (e.g., by executing a query that joins task database 410 and user database 409). At 606, task agent 402 can receive the historical and planned task data from task database 410.

At 608, task agent 402 can send a recommendation request to task service 406, where the request can include information received about the subject task (e.g., from client 401) and some or all of the historical and planned task data received from task database 410.

At 610, task service 406 can analyze the information in the recommendation request to recommend a start date and an expected effort for the subject task. In some embodiments, task service 406 can also recommend modifying the start date of one or more other tasks to accommodate work on the subject task. In some embodiments, task service 406 can use the techniques described below in the context of FIGS. 7 and 8 to generate said recommendations. At 612, task service 406 can send the recommendations back to task agent 402.

At 614, task agent 402 can cause the start date and expected effort of the subject task to be presented to client 401. For example, task agent 402 can cause one or more UIs of project management system 404 to be updated to display the recommended start date and expected effort.

At 616, task agent 402 can optionally cause the subject task to be updated in task database 410. In some cases, task agent 402 can also cause the start dates of one or more other tasks to be updated in 410 to accommodate work on the subject task, according to the recommendations returned by task service 406.

FIG. 7 shows an example of a process 700 for calculating a start date for a subject task, according to embodiments of the present disclosure. As one example, process 700 can be implemented within and performed by a task service, such as task service 406 of FIG. 4. As another example, some or all of process 700 can be implemented within and performed by a task agent, such as task agent 402 of FIG. 4.

At block 702, information about the subject task can be received. The information can include, for example, a title, one or more components, one or more labels, and a description. In some embodiments, the information can be received from a task agent that interfaces with a project management system, such as task agent 402 of FIG. 5. For example, the information may be received via an API request sent from the task agent. In other embodiments, the information can be received directly from the project management system (e.g., by a querying a database thereof).

At block 704, information about one or more other planned tasks can be received (e.g., via an API request or directly from a project management system). The information can include, for example, a title, one or more components, one or more labels, and a description for ones of the planned tasks. The other planned tasks can correspond to tasks assigned to the same user as the subject task and/or associated with the same project as the subject task. In some embodiments, the other planned tasks correspond to tasks that meeting the following conditions: (1) assigned to the same user, (2) associated with the same project, and (3) have a status other than “completed” or an equivalent value.

For each of the other planned tasks, process 700 can perform blocks 706a-706d, 708, as shown.

At blocks 706a-706d, discrete similarity scores can be calculated between a planned task and the subject task for various task attributes. In the example shown, discrete similarity scores are calculated for four task attributes: title, components, labels, and description. These attributes are merely illustrative and, in other embodiments, discrete similarity scores can be calculated for a different set of attributes. At block 706a, a similarity score can be calculated between a title of the planned task and a title of the subject task. At block 706b, a similarity score can be calculated between the components of the planned task and the components of the subject task. At block 706c, a similarity score can be calculated between the labels of the planned task and the labels of the subject task. At block 706d, a similarity score can be calculated between a description of the planned task and a description of the subject task.

In some embodiments, the following procedure can be used to calculate a discrete similarity score for a particular attribute (e.g., title, components, labels, description, etc.) between the planned task and the subject task.

First, the attribute value for both the planned task and the subject task can be converted to a string, as needed. In the case of title, description, or other single-valued attribute, the attribute value may already be represented as a string and thus no conversion may be needed. In the case of a task's components, labels, or other multi-valued attribute, strings representing the individual components may be joined together (e.g., concatenated together with a space between each components string) to form a single string representing the one or more components the task is associated with.

Next, sets of so-called “relevant keywords” can be identified for the subject task's attribute value and for the planned task's attribute value. That is, sets of words can be identified that are “relevant” or “important” for the purpose of calculating a similarity between the subject task and other planned tasks. A procedure for generating a set of relevant keywords from an attribute value of a given task is described next.

First, a list of preliminary keywords can be generated by splitting the attribute value (i.e., a string representation thereof) on word boundaries, such as spaces, tabs, and punctuation marks. The preliminary keywords can also be converted to lowercase. Thus, for example, assuming a task has the attribute value (e.g., title) of “Create a test case and run the unit test,” the generated preliminary keywords can be [“create”, “a”, “test”, “case”, “and”, “run”, “the”, “unit”, “test”].

Next, the preliminary keywords may be filtered to remove so-called “stop words.” Stop words can include common words in any language (like articles, prepositions, pronouns, conjunctions, etc.) that do not add much information to the text. Examples of stop words in English are “a,” “the,” “is,” “are,” “in,” “about,” “and,” etc. One or more lists of stop words can be used to filter the preliminary keywords. For example, a default list of stop words provided by the Natural Language Toolkit (NLTK) or another open-source project can be used. The default stop word list may be selected based on a language and/or geographic region associated with the user or the user's organization. In some embodiments, one or more custom lists of stop words can be used in addition to, or as an alternative to, the default stop word list. For example, in some embodiments, an organization can define a custom list of stop words to be used when intelligently managing tasks associated with that organization. Continuing with the example above, assuming that the words “a,” “and,” and “then” are all included within an applicable stop word list, the filtered keywords [“create”, “test”, “case”, “run”, “unit”, “test”] may be generated from the preliminary keywords [“create”, “a”, “test”, “case”, “and”, “run”, “the”, “unit”, “test”].

Next, the list of filtered keywords can be processed to identify a set of relevant keywords for the task's attribute value. In some embodiments, a TF-IDF measure can be used to determine the relevant keywords. TF-IDF stands for term frequency-inverse document frequency and it is a measure that can quantify the importance or relevance of string representations (words, phrases, lemmas, etc.) in a document amongst a collection of documents (also known as a corpus). In some embodiments, a “document” can correspond to an attribute value of a single task (e.g., the subject task's title) and a “corpus” can correspond to the corresponding attribute values of all tasks being processed (e.g., the title of the subject task received at block 702 and the titles of all other planned tasks received at block 704). In other embodiments, a “document” can correspond to an individual one of the filtered keywords for the given task and the “corpus” can correspond to the list of all filtered keywords for that task.

To calculate the relevance of (or the “importance of”) a particular one of the filtered keywords, K, the following equation may be used:

Imp(K)=TF·IDF,

wherein:

$$T F = \frac{{F}_{w}}{{F}_{m}} ,$$

$$IDF = log \frac{{N}_{t}}{{N}_{w} + 1} ,$$

and wherein F_{w} is the number of times the keyword K appears in document, Fₘ is the number of times the most frequent word within the document appears, Nₜ is the total number of documents in the corpus, and N_{w} is the total number of documents in the corpus that include the keyword K. The computed relevance/importance value Imp(K), having a value in the range [0,1], can then be used to determine if the keyword should be included within the set of relevant keywords generated for the task. For example, the computed relevance/importance value Imp(K) can be compared against a relevance threshold, T_{Imp}, to determine if the keyword should be included within the set of relevant keywords for the task. That is, keyword K may be included within the set of relevant keywords if and only if Imp(K)≥T_{Imp}, according to some embodiments. The relevance threshold T_{Imp}, which can have a value in the range [0,1], may be configurable for a given organization/project or across multiple organizations/projects. As one example, T_{Imp} can be 0.5.

The aforementioned TF-IDF-based determination can be applied to each unique keyword in the list of filtered keywords to determine which keywords are “relevant” or “important” for the purpose of calculating a similarity between the subject task and another planned task. Continuing the example from above, the filtered keywords [“create”, “test”, “case”, “run”, “unit”, “test”] could be processed to generate the set of relevant keywords {“test”, “case”, “unit”}, at least for some given corpus of tasks/keywords and some selected relevance threshold values, T_{Imp}.

Next, a similarity score can be calculated between the subject task and the planned task using the respective sets of relevant keywords. In some embodiments, this can include retrieving/generating trained word vectors for the relevant keywords determined for the subject tasks and for the relevant keywords determined for the other planned task, and then utilizing a cosine similarity measure to calculate the similarity score, as described next.

Briefly, trained word vectors (e.g., 256-dimension word vectors) can be retrieved for each of the relevant keywords determined for the subject task and the other planned task. A word vector is a vector of numbers that represent the meaning of a word. The numbers in the word vector represent the word's distributed weight across dimensions. Each dimension can represent a meaning and the word's numerical weight on that dimension captures the closeness of its association with and to that meaning. Thus, the semantics of the word are embedded across the dimensions of the vector. Blocks 706a-706d can retrieve pre-trained word vectors from an NLP library/toolkit (e.g., from an open-source NLP toolkit) and/or can generate its own trained word vectors using, e.g., the word2vec algorithm.

Next, a cosine similarity measure can be used to calculate a similarity score between the subject task and the other planned task using the respective trained words vectors. Cosine similarity is a measure of similarity between two non-zero vectors of an inner product space. It is defined to equal the cosine of the angle between them, which is also the same as the inner product of the same vectors normalized to both have length one (1).

Using the technique described above, block 706a can calculate a discrete similarity score, T(X), between the planned task's title and the subject task's title. Likewise, block 706b can calculate a discrete similarity score, C(X), between the planned task's components and the subject task's components; block 706c can calculate a discrete similarity score, L(X), between the planned task's labels and the subject task's labels; and block 706d can calculate a discrete similarity score, D(X), between the planned task's description and the subject task's description.

At block 708, an overall similarity score between the planned task and the subject task can be calculated using the discrete similarity scores. For example, a weighted sum of the discrete similarity scores can be calculated as follows:

Sim(X)=W_{T}·T(X)+W_{C}·C(X)+W_{L}·L(X)+W_{D}·D(X),

where weights W_{T}, W_{C}, W_{L}, W_{D} can be configurable for a given organization/project or across multiple organizations/projects. As one example, each of the W_{T}, W_{C}, W_{L}, W_{D} may have a value or 0.25 (i.e., equal weights can be used for the different attributes).

At block 710, the other planned tasks can be sorted by their respective overall similarity scores to determine which of the other planned tasks is most similar to the subject task.

At block 712, the start date of the subject task can be determined based on the start date and the expected effort of the most similar planned task, or equivalently, based on the end date of the most similar planned task. For example, if the most similar planned task is expected to be completed on Feb. 16, 2022, the start date for the subject task may be determined to be Feb. 17, 2022 (that is, this date may be recommended by task service as the start date for the subject task).

FIG. 8 shows an example of a process 800 for calculating an expected effort for a subject task, according to embodiments of the present disclosure. As one example, process 800 can be implemented within and performed by a task service, such as task service 406 of FIG. 4. As another example, some or all of process 800 can be implemented within and performed by a task agent, such as task agent 402 of FIG. 4.

In the following description of process 800, reference is made to using the titles of two different tasks to determine if those tasks are related. This is merely illustrative and other attributes of tasks can be used to determine similarity. For example, the description, components, or labels of two different tasks could be used, according to some embodiments. In some embodiments, process 800 can be adapted to utilize multiple different attributes for determining similarity between tasks.

At block 802, information about the subject task can be received. The information can include, for example, at least the title of the subject task. In some embodiments, the information can be received from a task agent that interfaces with a project management system, such as task agent 402 of FIG. 5. For example, the information may be received via an API request sent from the task agent. In other embodiments, the information can be received directly from the project management system (e.g., by a querying a database thereof).

At block 804, information about one or more historical tasks can be received (e.g., via an API request or directly from a project management system). The information can include, for example, the titles of the historical tasks. The historical tasks can correspond to tasks that have a status of “completed” (or an equivalent thereof) and that are assigned to, or were previously assigned to, the same user as the subject task or to a peer thereof (e.g., another user associated with the same organization, role, group, etc.). Notably, the historical tasks can include tasks associated with projects different from that of the subject task.

At block 806, one or more keywords can be determined for the subject task. In some embodiments, this can include generating a set of relevant keywords from the subject task's title using the procedure described above in the context of blocks 706a-706d of FIG. 7.

For each of the historical tasks, process 800 can perform some or all of blocks 808, 810, 812, 814, 816.

At block 808, one or more keywords can be determined for the historical task. In some embodiments, this can include generating a set of relevant keywords from the historical task's title using the procedure described above in the context of blocks 706a-706d of FIG. 7.

At block 810, a similarity score can be calculated between the subject task and the historical task. In some embodiments, this can include retrieving/generating trained word vectors for the relevant keywords determined for the subject task (at block 806) and for the relevant keywords determined for the historical task (at block 808), and then utilizing a cosine similarity measure to calculate the similarity score. Techniques for retrieving/generating trained word vectors and for using a cosine similarity measure are described above in the context of blocks 706a-706d of FIG. 7.

At block 812, the calculated similarity score can be compared to a similarity threshold. If the similarity score is greater than or equal to the threshold then, at block 816, the historical task can be added to a list of similar tasks. Otherwise, at block 814, the historical task may be discarded (i.e., not considered during the subsequent processing of process 800). The similarity threshold may be configuration per organization/project or for many organizations/projects. As one example, the similarity threshold may be 0.8.

At block 818, the list of similar historical tasks can be separated into two sub-lists: (1) similar tasks that are, or were, assigned to the same user as the subject task (“same-user tasks”), and (2) similar tasks that are, or were, assigned to peer users (“peer tasks”).

At block 820, an average of the actual effort for the same-user tasks can be calculated. For example, the same-user average, S_{avg}, can be calculated as:

$${S}_{a v g} = \frac{{S}_{1} + {S}_{2} + … {S}_{n}}{n}$$

where Sᵢ is the actual effort expended on the i^{th} same-user task and n is the number of same-user tasks in the sub-list.

At block 822, a weighted average of the actual effort for the peer tasks can be calculated. For example, the weighted average calculated

$${P}_{a v g} = \frac{{P}_{1} \cdot {q}^{{L}_{1} - {L}_{S}} + {P}_{2} \cdot {q}^{{L}_{2} - {L}_{S}} + … {P}_{m} \cdot {q}^{{L}_{m} - {L}_{S}}}{m}$$

where Pⱼ is the actual effort expended on the j^{th} peer task, m is the number of peer tasks in the sub-list, Lⱼ represents a level of the peer user that worked on the j^{th} task, L_{S} represents a level of the user to whom the subject task is assigned, and q is a constant representing a standard productivity difference between users of different levels. In some embodiments, constant q may be configurable for a given organization/project or across many organizations/projects.

As used herein, the term “level” used in conjunction with a user refers to numerical value that approximates how efficient that user is relative to the user's peers. In some embodiments, the level of a user may be determined based on their role within an organization. For example, a user having the role of “Senior Software Engineer” may be deemed to have a higher level than a user having the role of “Junior Software Engineer.” In some embodiments, process 800 can utilize a mapping of roles to level values to determine a user's level, and the mapping may be configurable for a given organization/project or across many organizations/projects. In some embodiments, process 800 can automatically lookup a user's role from a project management system (e.g., project management system 404 of FIG. 4) or from another system/application (e.g., an HR application) using an API provided thereby.

At block 824, the expected effort for the subject task can be calculated using the averages from blocks 820 and 822. For example, the expected effort, Eₑₓₚ, can be calculated using the following formula:

Eₑₓₚ=W_{S}·S_{avg}+W_{P}·P_{avg}

where W_{S} is a weight given to same-user tasks and W_{P} is a weight given to peer tasks. The weights W_{S}, W_{P} can be configurable for a given organization/project or across many organizations/projects. In one example, W_{S}=0.8 and W_{P}=0.2.

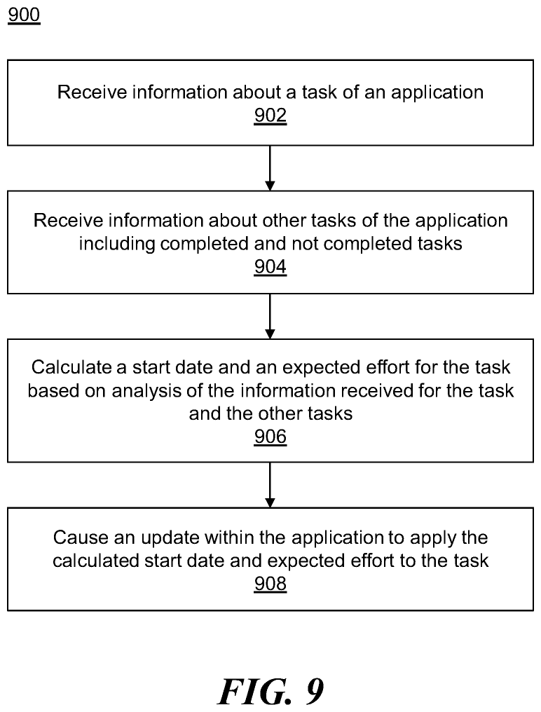

FIG. 9 shows an example of a process 900 that can be implemented within a task service, according to embodiments of the present disclosure.

At block 902, information can be received about a task of application (“subject task”), where the task is associated with a project. At block 904, information can be received about other tasks of the application including completed and not completed tasks. The not completed tasks can include, for example, other planned tasks that are assigned to the same user as the subject task and/or associated with the same project as the subject task. The completed tasks can include, for example, tasks that were completed by, previously assigned to, or otherwise associated with users different from the user to whom the subject task is assigned. In some cases, the completed tasks can be associated with a different project than the subject task.

In some embodiments, the application may correspond to a project management system/application, such as JIRA or WRIKE. In some embodiments, the information about the subject task and the other tasks can be received from an agent running within the application (e.g., a plugin/extension to the project management system).

At block 906, a start date and an expected effort for the subject task can be calculated based on analysis of the information received for the subject task and the other tasks. Any of the techniques described above in the context of FIGS. 7 and 8 can be used calculate the start date and expected effort.

In some embodiments, calculating the start date can include calculating similarity scores between the subject task and ones of the other not completed tasks using the received information. The start date of the subject task can then be determined based on the not completed task which has the highest similarity score. For example, the start date of the subject task can be calculated based on the end date of the most similar task or, equivalently, the start date and expected effort of the most similar task. In some embodiments, calculating a similarity score between the subject task and one of the other not completed can include calculating discrete similarity scores for multiple different task attributes (e.g., title, description, etc.) and then calculating an overall similarity scores as a weighted sum of the discrete similarity scores.

In some embodiments, calculating the subject task's expected effort can include identifying ones of the completed tasks that are similar to the subject task based on comparing the received information and then calculating an average of actual effort expended on the similar, completed tasks. In some embodiments, to determine if one of the completed tasks is similar to the subject task, a set of relevant keywords for the subject task can be identified (e.g., using a TF-IDF measure), a set of relevant keywords for the completed task can be identified (e.g., also using a TF-IDF measure), and then a similarity score can be calculated using the two sets of relevant keywords (e.g., using a cosine similarity measure). In some embodiments, the identified similar completed tasks can be separated into two sub-lists: tasks associated to the same user as the subject task, and tasks associated with peers. Separate averages can be calculated for the two sub-lists, and the separate averages can be completed (e.g., as a weighted sum) to generate an overall average.

At block 908, an update can be caused within the application to apply the calculated start date and expected effort to the subject task. For example, a task service can send a response to a task agent configured to update the task within a database and/or to update one or more UI controls being used to create/edit/view the subject task.

In some embodiments, process 900 can further include calculating modified start dates for one or more of the other not completed tasks, and causing the one or more other tasks to be updated within the application to apply the modified start dates.

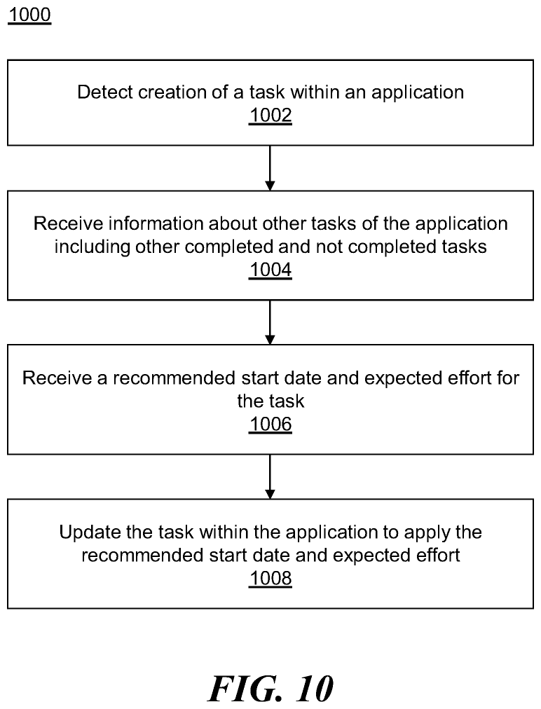

FIG. 10 shows an example of a process 1000 that can be implemented within a task agent, according to embodiments of the present disclosure.

At block 1002, creation of a task (“subject task”) within an application (e.g., a project management system/application) can be detected, the subject task being associated with a project. In some embodiments, this can include detecting an input on a user interface (UI) control of the application.

At block 1004, information about other tasks of the application can be received, including other tasks that have been completed and other tasks that have not been completed. For example, the information about the other tasks can be retrieved from a database of the project management system.

At block 1006, a recommended start date and expected effort for the subject task can be received using the information received for the subject task and the other tasks. In some embodiments, this can include sending a request to a task service, the requesting including the information about the subject task and the information received about other tasks of the application.

At block 1008, the subject task can be updated within the application to apply the recommended start date and expected effort to the subject task. In some embodiments, this can include updating one or more UI controls of the application to display the calculated start date and expected effort. In some embodiments, block 1008 can include updating a database to store the calculated start date and expected effort for the subject task.

The following examples pertain to further embodiments, from which numerous permutations and configurations will be apparent.

Example 1 includes a method including: receiving, by a computing device, information about a task of application, the task associated with a project; receiving, by the computing device, information about other tasks of the application including other tasks that have been completed and other tasks that have not been completed; calculating, by the computing device, a start date and an expected effort for the task based on analysis of the information received for the task and the other tasks; and causing, by the computing device, an update within the application to apply the calculated start date and expected effort to the task.

Example 2 includes the subject matter of example 1, wherein the information about the task and the other tasks is received from an agent running within the application.

Example 3 includes the subject matter of examples 1 or 2, wherein the receiving of the information about the other tasks that have not been completed includes receiving information about tasks assigned to the same user as the task and associated with the same project as the task.

Example 4 includes the subject matter of any of examples 1 to 3, wherein the calculating of the start date for the task includes: calculating similarity scores between the task and ones of the other tasks that have not been completed using the information received about the task and the other tasks that have not been completed; determining a task from among the other tasks that have not been completed having a highest one of the calculated similarity scores; and calculating the start date of the task based on an end date of the task from among the other tasks that have not been completed having the highest one of the calculated similarity scores.

Example 5 includes the subject matter of any of example 4, wherein the information received about the task includes values of the task for a plurality of attributes, wherein the information received about the other tasks that have not been completed includes values of the ones of the other tasks that have not been completed for the plurality of attributes, and wherein calculating the similarity score between the task and one of the other tasks that have not been completed includes: for ones of the plurality of attributes, calculating discrete similarity scores between the task and the one of the other tasks that have not been completed using the corresponding attribute values received for the task and the one of the other tasks that has not been completed; and calculating the similarity scores as a weighted sum of the discrete similarity scores.

Example 6 includes the subject matter of any of examples 1 to 5, wherein the receiving of the information about other tasks that have been completed includes receiving information about other tasks that have been completed by users different from a user to whom the task is assigned.

Example 7 includes the subject matter of any of examples 1 to 6, wherein the receiving of the information about other tasks that have been completed includes receiving information about other tasks that are associated with another project different from the project with which the task is associated.

Example 8 includes the subject matter of any of examples 1 to 7, wherein the calculating of the expected effort for the task includes: identifying ones of the other tasks that have been completed that are similar to the task based on comparing the information received about the task and the other tasks that have been completed; and calculating an average of actual effort expended on the ones of the tasks that have been completed that are similar to the task.

Example 9 includes the subject matter of any of examples 1 to 8, wherein the identifying of the ones of the other tasks that have been completed that are similar to the task includes: identifying keywords within the information received for the task; for ones of the other tasks that have been completed: identifying keywords within the information received for the one of the other tasks that have been completed; and calculating a similarity score between the task and the one of the other tasks that have been completed using the respective keywords.

Example 10 includes the subject matter of example 9, wherein the identifying of the keywords within the information received and the identifying of the keywords within the information received for the ones of the other tasks that have been completed includes using a term frequency-inverse document frequency (TF-IDF) measure.

Example 11 includes the subject matter of example 9, wherein the calculating of the similarity score between the task and the one of the other tasks that have been completed using the respective keywords includes using a cosine similarity measure.

Example 12 includes the subject matter of example 8, wherein the calculating of the average of the actual effort expended on the ones of the tasks that have been completed that are similar to the task includes: separating the ones of the tasks that have been completed that are similar to the task into first similar tasks that are assigned to a user to whom the task is also assigned and second similar tasks that are assigned to users other than the user to whom the task is assigned; calculating an average of actual effort expended on the first similar tasks; and calculating a weighted average of actual effort expended on the second similar tasks.

Example 13 includes the subject matter of example 12, wherein the calculating of the weighted average of the actual effort expended on the second similar tasks includes, for ones of the second similar tasks, determining a weight based on a difference in level of the user to whom the one of the second similar tasks is assigned and the user to whom the task is assigned.

Example 14 includes the subject matter of any of examples 1 to 13, and further including: responsive to the calculating of the start date for the task, determining a modified start date for at least one of the one or more of the other tasks that have not been completed; and causing an update within the application to apply the modified start date to the at least one of the one or more of the other tasks that have not been completed within the application.

Example 15 includes a method including: detecting, by a computing device, creation of a task within an application, the task associated with a project; receiving, by the computing device, information about other tasks of the application including other tasks that have been completed and other tasks that have not been completed; receiving, by the computing device, a recommended start date and expected effort for the task using the information received for the task and the other tasks; and updating, by the computing device, the task within the application to apply the recommended start date and expected effort to the task.

Example 16 includes the subject matter of example 15, wherein the detecting of the creation of a task within an application includes detecting of the creation of the task includes detecting an input on a user interface (UI) control of the application.

Example 17 includes the subject matter of example 15 or 16, wherein the updating of the task within the application includes update one or more UI controls of the application to display the calculated start date and expected effort.

Example 18 includes the subject matter of any of examples 15 to 17, wherein the updating of the task within the application includes updating a database to store the calculated start date and expected effort for the task.

Example 19 includes the subject matter of any of examples 15 to 18, wherein the receiving of the recommended start date and expected effort for the task includes sending a request to another computing device, the request including information about the task and the information received about other tasks of the application.

Example 20 includes a computing device comprising: a processor and a non-volatile memory storing computer program code that when executed on the processor causes the processor to execute a process, the process including the subject matter of any of examples 1 to 19.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
receiving, by a computing device, information about a task of application, the task associated with a project;
receiving, by the computing device, information about other tasks of the application including other tasks that have been completed and other tasks that have not been completed;
calculating, by the computing device, a start date and an expected effort for the task based on analysis of the information received for the task and the other tasks; and
causing, by the computing device, an update within the application to apply the calculated start date and expected effort to the task.

2. The method of claim 1, wherein the information about the task and the other tasks is received from an agent running within the application.

3. The method of claim 1, wherein the receiving of the information about the other tasks that have not been completed includes receiving information about tasks assigned to the same user as the task and associated with the same project as the task.

4. The method of claim 1, wherein the calculating of the start date for the task includes:
calculating similarity scores between the task and ones of the other tasks that have not been completed using the information received about the task and the other tasks that have not been completed;
determining a task from among the other tasks that have not been completed having a highest one of the calculated similarity scores; and
calculating the start date of the task based on an end date of the task from among the other tasks that have not been completed having the highest one of the calculated similarity scores.

5. The method of claim 4, wherein the information received about the task includes values of the task for a plurality of attributes, wherein the information received about the other tasks that have not been completed includes values of the ones of the other tasks that have not been completed for the plurality of attributes, and wherein calculating the similarity score between the task and one of the other tasks that have not been completed includes:
for ones of the plurality of attributes, calculating discrete similarity scores between the task and the one of the other tasks that have not been completed using the corresponding attribute values received for the task and the one of the other tasks that has not been completed; and
calculating the similarity scores as a weighted sum of the discrete similarity scores.

6. The method of claim 1, wherein the receiving of the information about other tasks that have been completed includes receiving information about other tasks that have been completed by users different from a user to whom the task is assigned.

7. The method of claim 1, wherein the receiving of the information about other tasks that have been completed includes receiving information about other tasks that are associated with another project different from the project with which the task is associated.

8. The method of claim 1, wherein the calculating of the expected effort for the task includes:
identifying ones of the other tasks that have been completed that are similar to the task based on comparing the information received about the task and the other tasks that have been completed; and
calculating an average of actual effort expended on the ones of the tasks that have been completed that are similar to the task.

9. The method of claim 8, wherein the identifying of the ones of the other tasks that have been completed that are similar to the task includes:
identifying keywords within the information received for the task;
for ones of the other tasks that have been completed:
identifying keywords within the information received for the one of the other tasks that have been completed; and
calculating a similarity score between the task and the one of the other tasks that have been completed using the respective keywords.

10. The method of claim 9, wherein the identifying of the keywords within the information received and the identifying of the keywords within the information received for the ones of the other tasks that have been completed includes using a term frequency-inverse document frequency (TF-IDF) measure.

11. The method of claim 9, wherein the calculating of the similarity score between the task and the one of the other tasks that have been completed using the respective keywords includes using a cosine similarity measure.

12. The method of claim 8, wherein the calculating of the average of the actual effort expended on the ones of the tasks that have been completed that are similar to the task includes:
separating the ones of the tasks that have been completed that are similar to the task into first similar tasks that are assigned to a user to whom the task is also assigned and second similar tasks that are assigned to users other than the user to whom the task is assigned;
calculating an average of actual effort expended on the first similar tasks; and
calculating a weighted average of actual effort expended on the second similar tasks.

13. The method of claim 12, wherein the calculating of the weighted average of the actual effort expended on the second similar tasks includes, for ones of the second similar tasks, determining a weight based on a difference in level of the user to whom the one of the second similar tasks is assigned and the user to whom the task is assigned.

14. The method of claim 1, further comprising:
responsive to the calculating of the start date for the task, determining a modified start date for at least one of the one or more of the other tasks that have not been completed; and
causing an update within the application to apply the modified start date to the at least one of the one or more of the other tasks that have not been completed within the application.

15. A method comprising:
detecting, by a computing device, creation of a task within an application, the task associated with a project;
receiving, by the computing device, information about other tasks of the application including other tasks that have been completed and other tasks that have not been completed;
receiving, by the computing device, a recommended start date and expected effort for the task using the information received for the task and the other tasks; and
updating, by the computing device, the task within the application to apply the recommended start date and expected effort to the task.

16. The method of claim 15, wherein the detecting of the creation of a task within an application includes detecting of the creation of the task includes detecting an input on a user interface (UI) control of the application.

17. The method of claim 15, wherein the updating of the task within the application includes update one or more UI controls of the application to display the calculated start date and expected effort.

18. The method of claim 15, wherein the updating of the task within the application includes updating a database to store the calculated start date and expected effort for the task.

19. The method of claim 15, wherein the receiving of the recommended start date and expected effort for the task includes sending a request to another computing device, the request including information about the task and the information received about other tasks of the application.

20. A computing device comprising:
a processor; and
a non-volatile memory storing computer program code that when executed on the processor causes the processor to execute a process comprising:
receiving information about a task of application, the task associated with a project;
receiving information about other tasks of the application including other tasks that have been completed and other tasks that have not been completed;
calculating a start date and an expected effort for the task based on analysis of the information received for the task and the other tasks; and
causing an update within the application to apply the calculated start date and expected effort to the task.
